(19) United States
(12) Patent Application Publication
(10) Pub. No.: US 2009/0155441 A1
(43) Pub. Date: Jun. 18, 2009

(54) PARTIAL SUGAR REPLACEMENT WITH SINGLE HIGH INTENSITY SWEETENER ACESULFAME K

(76) Inventor: Katrin Salzer, Kahl/Main (DE)

Correspondence Address: HAMMER & ASSOCIATES, P.C., 3125 SPRINGBANK LANE, SUITE G, CHARLOTTE, NC, 28226, US

(21) Appl. No.: 11/948,366

(22) Filed: Nov. 30, 2007

(51) Int. Cl. A23L 1/30; A23L 1/236

(52) U.S. Cl. 426/548

(57) ABSTRACT

The invention concerns a method of reducing the amount of added sugar in food and beverages, comprising adding a fraction of the typically added amount of sugar to the food or beverage, wherein the lost sweetness is compensated with Acesulfame K as the only high intensity sweetener.

### BACKGROUND OF THE INVENTION

1. Field of the Invention

Rising obesity as effect of modern lifestyle and nutrition results in an increase in health-consciousness and desire to reduce calories for many consumers. Better information about nutritional value of regularly consumed foods should help to achieve a more balanced everyday nutrition.

New developments such as the new EU heath-claim directive (No 1924/2006), the draft of the South African “Regulation relating to labelling and advertising of foodstuff No 30075” as an example demonstrate the worldwide interest in healthy choices for nutrition.

The growing market of “diet” foodstuff is evidence for the importance of calorie reduction in human modern nourishment. Beside developing more and more “light” or “diet”-variants of foodstuff and beverages with no added sugar or minimum amount of fat, there is a growing demand for even lowering the calorie content of “regular” products to offer reduced calorie-alternatives for everyday's nutrition, so that the overall calorie intake is reduced on a long term base instead of frequent alteration between slimming and regular nutrition.

Especially for long term acceptance by end-consumers in daily nutrition, high quality taste is critical, even more than the maximum possible calorie reduction. Compromises in taste will probably only be made for a limited time-period, ie during a diet, but not during everyday's life.

In order to ensure a consequent, life-long healthy nutrition an enduring acceptance and usage of food and beverage products is attributed a higher priority than the maximum of possible reduction in calories.

The above described consumer environment generates a need to develop beverages and foodstuff with somewhat reduced calories, achieved by sugar or fat reduction, but with a priority on absolutely no-compromise in taste quality including the sweet taste sensation, flavour and mouthfeel perception.

Secondly, consumer awareness and concerns against artificial ingredients which might effect their health are growing, leading to avoidance of too many artificial ingredients and modifiers in prepared foods and beverages for a balanced diet. As a result, there is a need to develop foodstuff with a short ingredient list, especially with regard to artificial ingredients and minimisation of usage of artificial taste modifiers. At least those ingredients which are well known by end-consumers and discussed in the media for potential adverse effects or mandatory warning labels should be avoided for consumer image reasons.

2. Prior Art

Quite a number of references deal with various options and recommendations to improve taste quality of sugar reduced and no added sugar food and beverages. They all suggest that mixtures of two or more high intensity sweeteners offer sweetness profiles, flavour perceptions and overall taste sensations which are much closer to the taste sensation of sugar than each of the high intensity sweeteners when used alone.

WO 2007/078293 describes a juice based beverage with reduced sugar and, thus calories, where the sweetness is preferably delivered by a combination of Acesulfame K and Aspartame to offer a sugar like sweet taste over the shelf-life of the beverage. This combination is recommended, even if a certain amount of nutritive sweeteners—either added or from fruit juice—is present in this beverage.

A mixture of at least four different artificial sweeteners is disclosed in DD298989 to sweeten food and beverages. Those mixtures offer beneficial synergies regardless of whether or not further carbohydrates—such as sucrose, glucose or fructose—are part of this formulation. According to Hoppe this multi-mixture is necessary to achieve a pleasant sugar like taste.

In a series of publications [“Adjusting Sunett to flavours”, World of food ingredients December 2000; “Custom-tailored sweetness for fruit flavours”, Soft Drinks international, September 2001; “Sweeteners in Cola: Optimisations though Taste Interactions”, Soft Drink International February 2002; “Fine tuning sweetener blends in Lemon-Lime Drinks” International Food Ingredients, April/May 2003] the author, Dr Susanne Rathjen, describes in detail sensory studies aimed to find most sugar like sweetening systems for various beverage systems. Depending on the beverage system and the flavour used, various combinations of high intensity sweeteners are recommended.

Even if natural high intensity sweeteners are used a mixture of two or more sweetening agents is preferable (US 2007/010484; Stevia and erythritol in varying ratios).

Attempts have been made to improve those sweetener blends further by addition of taste modifiers or other ingredients to achieve a taste as close to sugar as possible but with a minimum of calories by no addition of sugar.

US 2002/0004092 discloses the use of arabinogalatans to improve the taste of various soft drinks sweetened with mixtures of high intensity sweeteners such as Acesulfam K and Aspartame or Saccharin and Aspartame.

In U.S. Pat. No. 6,432,464 further taste improvements and synergies of Acesulfame K Aspartame mixtures with Tagatose are suggested for the use in beverages.

Another option to enhance the taste of high intensity sweetener blends in various food products is given in EP 0946111 and EP 0946112, were fructo-oligosaccharides or oligosaccharides in general are recommended to be combined with either Acesulfame K and Aspartame or other artificial sweetener mixtures.

US 2002/0187233 discloses the use of modified food starches to mask unpleasant aftertaste of high intensity sweeteners and their combinations.

Different attempts have been made to improve the taste of sugar-reduced food and beverages by combining nutritive and none-nutritive sweeteners to address end-consumers that are not looking for diet products, but for regular foodstuff with “regular” taste that still offer caloric benefits.

In “Physicochemical and psychophysical characteristics of binary mixtures of bulk and intense sweeteners” F. Hutteau et al. (Food chemistry vol 63, No 1, 6-19, 1998) summarise the physical differences which they determined in solutions of mixtures of high intensity sweeteners such as alitame, aspartame, Acesulfame K and cyclamate with sugar in various blend ratios. These blends of sugar and sweeteners were compared to solutions of sugar, and differences in viscosity and surface tension were analysed. No indication of similarities with regard to taste quality of these physically different solutions is given.

J. Fry (Sugar replacement in non-diet soft drinks, Food Technology International Europe, 83-86, 1995) describes 30 and 50% calorie reduced sweetening concepts in cola and lemonades using combinations of either glucose sirup and aspartame or low-fructose syrups and aspartame. Using a consumer panel it was shown that the taste profile of none of these sweetening systems was similar to sucrose. In fact the glucose syrup/aspartame and low-fructose syrup/aspartame mixtures showed statistically significant differences in sweetness, acidity, sweet aftertaste, bitter aftertaste, length of aftertaste, liking for aftertaste, mouthfeel, odour liking, flavour liking and overall liking.

To overcome the mentioned disadvantages of taste differences compared to the “regular”, sugar-counterparts of the described food and beverage, again mixtures of various high intensity sweeteners have been recommended to achieve a maximum reduction in calories with acceptable taste for those diet products.

“Sweeteners in Beverages—new Developments”, Andreas Lotz and Eike Meyer, Food Marketing and Technology, April 1994 shows the option of combining sucrose with a mixture of high intensity sweetener consisting of two to three artificial sweeteners and a maximum of 40 g/l sucrose.

“Breaking the Boundaries”, Susanne Meyer, Liquid Food and Drink Technology, January 2002 extends the concept of mixing high intensity sweeteners to mixtures with caloric sweeteners—such as sucrose or high fructose corn syrup—and artificial sweeteners i.e blends of Acesulfame K and Sucralose. The concept focuses on a maximum reduction of sugar—namely up to 80% sugar replacement—and calories by using a high intensity sweetener combination adapted to the flavour system used.

“Combinations of glucose syrups and intense sweetern, application in calorie reduced soft drinks” J.Simon et al in FIE (Food ingredients Europe. Conference proceedings, Paris 27, 28, 29 September 1989’. Maarssen, Netherlands; Expoconsult Publishers, 330-333, 1989) discloses that mixtures of artificial sweeteners are superior in taste to single sweeteners and, thus, again combinations and multi-mixtures are recommended.

US2007048425 discloses that mixtures of sweetener blends like Acesulfame K and aspartame or Acesulfame K and Sucralose can replace the sweetness of at least 50% of the normal high fructose corn syrup (HFCS) content in foodstuff but offering a taste quality comparable to the usage of sucrose.

Also, WO2006/074881 and US2006134291 describe combinations of Acesulfame K and Aspartame or Sucralose or Neotame to replace the sweetness of at least 50% of the High fructose corn syrup or sugar content used in regular foodstuff still offering the same taste than with the original content of caloric sweetener respective HFCS or sucrose.

The need for further taste optimisation of blends of Sucralose with nutritive sweeteners and artificial sweeteners, such as combinations of Sucralose, Acesulfame K and sucrose or HFCS in Cola beverages by the addition of tannic acid compounds in cola beverages is described in U.S. Pat. No. 6,265,012.

To fulfill the requirements of end-consumers for a balanced, calorie conscious nutrition with high taste quality there remains to be a need for sugar reduced, regular food-products that use a minimum of artificial ingredients to minimise consumer image-concerns caused by too many artificial ingredients listed on the packaging or warning labels due to used artificial ingredients.

### BRIEF SUMMARY OF THE INVENTION

Generally this invention addresses the above mentioned need to reduce a certain amount of calories in regular, non-diet food and beverage products by decreasing a certain predetermined amount of sugar in the food or beverage and simultaneous replacement of the lost sweetness by the addition of a single high intensity sweetener.

In particular the invention relates to a certain reduction of sugar and simultaneous replacement of the lost sweetness by the high intensity sweetener Acesulfame K.

An even more preferred embodiment of this invention comprises a beverage wherein 20 to a maximum of 40% (by weight) of the typically added sugar (compared to a regular beverage on the market), which typically ranges between 4 and 14 g/100 ml total sugar, is replaced by the equi-sweet amount of Acesulfame K only.

Surprisingly this replacement with Acesulfame K as the one and only replacement has shown good sensory quality. This was especially surprising, since other frequently used high intensity sweeteners such as Aspartame or Sucralose did not show these beneficial effects when used alone. Moreover, various publications explain the need of blends of various high intensity sweeteners to achieve a pleasant, sugar-like taste sensation.

### DETAILED DESCRIPTION OF THE INVENTION

The present invention provides a method of reducing the amount of added sugar in food and beverages, which method comprises adding only a fraction of the typically added amount of sugar to a food or beverage, thereby creating a loss of sweetness, wherein the lost sweetness is compensated with Acesulfame K as a single high intensity sweetener.

“Sugar” as used herein is understood (according to EU Directive 94/35/EC) as all mono- and disaccharides or any other foodstuff added for its sweetening properties independently from its physical state (in dry or liquid forms). Non limiting examples are saccharose, lactose, glucose, fructose, isomaltulose, Tagatose, sugar syrup, liquid sugar, corn syrup, hydrolysed starch syrup, glucose syrup, fructose syrup, high fructose corn syrup, honey, fruit juice concentrates or extracts and combinations thereof.

The method for reducing sugar is generally applicable to all food and beverages; preferably it is used in fermented and non fermented dairy-products, backed goods, confectionary, fruits, vegetables, fruit-and vegetable-preparations, processed fruit and vegetables and beverages. Non limiting examples for dairy products are yoghurt plain, with fruit or flavour; drinkable yoghurt, plain, with fruit or flavour, lactic acid drinks, quark (white cheese), “fromage frais”, milk, flavoured milk drinks, milk- and dairy desserts, concentrated or condensed milk products. Non limiting examples for backed goods are cake, biscuits, tarts, cookies, sweet bread, sweet rolls, muffins, doughnuts, including fruit- cream- and chocolate or other fillings and toppings for bakery. Non limiting examples for confectionary are hard and soft candy, mints, chewable candy, chewing gum, chocolate, gum or gelatine based confectionary, breath-freshener. Non limiting examples for beverages are carbonated soft drinks, no carbonated drinks, fruit juice based drinks, still drinks, alcoholic and non alcoholic drinks, dilutables, cordials and syrups, dry mix or powdered beverages, sports drinks, ready to drink tea and coffee, ice tea, milk drinks, flavoured water, hot drinks such as fresh brewed tea, coffee or cacao.

Most preferably the sugar reduction according to this invention is used for fermented dairy products such as yoghurt and yoghurt containing drinks and beverages, such as carbonated and un-carbonated drinks, fruit juice base drinks, still drinks, ice tea, cordials, dilutables and powdered or dry mix beverages.

The term “equi-sweetness” or “equi-sweet” as used herein means a sweet taste sensation, flavour and mouthfeel perception like the to be substituted sugar.

In the present invention the amount of sugar typically added to a foodstuff or beverage (typically between 4 and 14 g/100 ml total sugar) is lowered and replaced—sweetness wise not weight wise—by Acesulfame K. The amount of sugar replaced according to this invention is preferably up to 40 wt.-% of the original (to be added) sugar content, in particular a level of 20 to 30 wt.-% of sugar replacement is achieved.

Beside the (to be) added sugar, which is considered for replacement, the foodstuff may contain varying amounts of sugar/carbohydrates naturally occurring therein.

The reduction in added sugar leads to a reduction in sweetness. This lost sweetness is compensated by the addition of Acesulfame K as the one and only added artificial sweetener. The amount of Acesulfame K added is such that it is equi-sweet to the to be replaced sugar; the combination of “left over sugar” and Acesulfame K results in a food or beverage which is equi-sweet to its fully sugared version. Every person skilled in the art of sweeteners can easily determine the amount of Acesulfame K which is necessary to compensate for the lost sweetness (intensity). Reference “Acesulfame-K”, D. G. Mayer, F. H. Kemper, Marcel Dekker, Inc., New York, 1991, p. 199 ff. can be used as a guidance.

When sugar is replaced partially by Acesulfame K it was surprisingly found, that in contrast to common literature the resulting food taste is indistinguishable from a full sugared comparison. The flavour profile, sweetness profile, mouthfeel and overall taste perception was equal to a full sugared version. This was especially surprising, since other high intensity sweeteners used in market products and described in literature like aspartame, Sucralose or Neotame, when used as the only substitute, did not result in such a very sugar like taste quality.

It has, moreover, been found that the sweetness-replacement by using Acesulfame K according to the present invention in a beverage product which additionally contains phosphoric acid as acidulant or a combination of phosphoric acid and citric acid is specifically advantageous since the calorie-lowered beverage can hardly be detected in a comparison with the fully sugared beverage. This is even more pronounced in carbonated cola and lemon and/or lime beverages.

As further demonstrated in the following examples, sugar replacement according to this invention fulfils advantageously the need to reducing sugar content, thus slightly reducing calories, in regular and regular like tasting foodstuff with a minimum of artificial ingredients used. Additionally this method results in a “clean” label, as Acesulfame K as widely known sweetener does not raise any end consumer concerns and does not need any additional warning label.

### EXAMPLES

### 1) Cola Flavoured Carbonated Soft Drink:

Different cola flavoured carbonated soft drinks are prepared in a usual way according to the recipes in table 1 to 4. All sugar replaced formulations are compared to the equi-sweet, full sugared-standard formula by a Duo-Trio test. In this sensory test, 34 to 37 panellists are served in a balanced order with two randomly coded samples and a known standard formula. They are asked to determine which of the two coded samples is identical to the standard formula. Since this is a forced choice method, there is a possibility to determine whether there is a statistically significant difference between the two samples or not. Two samples are regarded as statistically significant different only if the likelihood of difference is higher than 90%; otherwise it is assumed, that panellists have chosen the right sample just by chance.

TABLE 1

| | | 1.2 40% Partial sugar |
|---|---|---|
| | 1.1 Sugar | replacement with |
| | comparison | Acesulfame K |
| Cola base g/l (Döhler | 3.1 | 3.1 |
| Darmstadt, Art. Nr 200380) | | |
| Saccharose g/l | 100 | 60 |
| Acesulfame K mg/l | | 156 |
| Water | Ad 1000 ml | Ad 1000 ml |
| CO₂ g/l | 6 | 6 |

| | |
|---|---|
| Number of panellists | 37 |
| Correct answers | 21 |
| Likelihood of difference | 74% |
| Significant? | NO |

TABLE 2

| | | 1.3 40% Partial sugar |
|---|---|---|
| | 1.1 Sugar | replacement |
| | comparison | with Aspartame |
| Cola base g/l (Döhler | 3.1 | 3.1 |
| Darmstadt, Art. Nr 200380) | | |
| Saccharose g/l | 100 | 60 |
| Aspartame mg/l | | 236 |
| Water | Ad 1000 ml | Ad 1000 ml |
| CO₂ g/l | 6 | 6 |

| | |
|---|---|
| Number of panellists | 37 |
| Correct answers | 23 |
| Likelihood of difference | 91% |
| Significant? | YES |

TABLE 3

| | 1.1 Sugar | 1.4 20% Partial sugar |
|---|---|---|
| | comparison | replacement with Neotame |
| Cola base g/l (Döhler | 3.1 | 3.1 |
| Darmstadt, Art. Nr 200380) | | |
| Saccharose g/l | 100 | 80 |
| Neotame mg/l | | 5 |
| Water | Ad 1000 ml | Ad 1000 ml |
| CO₂ g/l | 6 | 6 |

| | |
|---|---|
| Number of panellists | 34 |
| Correct answers | 26 |
| Likelihood of difference | 99% |
| Significant? | YES |

TABLE 4

| | 1.1 Sugar | 1.5 10% Partial sugar |
|---|---|---|
| | comparison | replacement with Sucralose |
| Cola base g/l (Döhler | 3.1 | 3.1 |
| Darmstadt, Art. Nr 200380) | | |
| Saccharose g/l | 100 | 90 |
| Sucralose mg/l | | 15.6 |
| Water | Ad 1000 ml | Ad 1000 ml |
| CO₂ g/l | 6 | 6 |

| | |
|---|---|
| Number of panellists | 35 |
| Correct answers | 24 |
| Likelihood of difference | 98% |
| Significant? | YES |

These sensory tests demonstrate clearly the surprisingly good performance of Acesulfame K for partial sugar replacement, as a high ratio of sugar replacement (40%) can be achieved without significant difference to a full-sugared Cola Drink. All other tested high intensity sweetener tasted different to the full sugared cola even if a lower ratio of sugar replacement was used.

### 2) Lemon Lime Flavoured Carbonated Soft Drink

Like in example 1, various Lemon Lime flavoured, carbonated soft drinks were prepared according to Tables 5 to 7. Sensory evaluation of these beverages was carried out as described in example 1. Results are summarised in the following tables.

TABLE 5

| | | 2.2 30% Partial sugar |
|---|---|---|
| | 2.1 Sugar | replacement with |
| | comparison | Acesulfame K |
| Lemon Lime Flavour g/l | 0.65 | 0.65 |
| (Sensient Nr. 1013981) | | |
| Citric acid * H₂O g/l | 2.0 | 2.0 |
| Phosphoric acid (85%) g/l | 0.5 | 0.5 |
| Sodium Benzoate g/l | 0.15 | 0.15 |
| Saccharose g/l | 100 | 70 |
| Acesulfame K mg/l | | 120 |
| Water | Ad 1000 ml | Ad 1000 ml |
| CO₂ g/l | 5 | 5 |

| | |
|---|---|
| Number of panellists | 35 |
| Correct answers | 13 |
| Likelihood of difference | 5% |
| Significant? | NO |

TABLE 6

| | 2.1 Sugar | 2.3 30% Partial sugar |
|---|---|---|
| | comparison | replacement with Aspartame |
| Lemon Lime Flavour g/l | 0.65 | 0.65 |
| (Sensient Nr. 1013981) | | |
| Citric acid *H₂O g/l | 2.0 | 2.0 |
| Phosphoric acid (85%) g/l | 0.5 | 0.5 |
| Sodium Benzoate g/l | 0.15 | 0.15 |
| Saccharose g/l | 100 | 70 |
| Aspartame mg/l | | 144 |
| Water | Ad 1000 ml | Ad 1000 ml |
| CO₂ g/l | 5 | 5 |

| | |
|---|---|
| Number of panellists | 35 |
| Correct answers | 22 |
| Likelihood of difference | 91% |
| Significant? | YES |

TABLE 7

| | 2.1 Sugar | 2.4 20% Partial sugar |
|---|---|---|
| | comparison | replacement with Sucralose |
| Lemon Lime Flavour g/l | 0.65 | 0.65 |
| (Sensient Nr. 1013981) | | |
| Citric acid * H₂O g/l | 2.0 | 2.0 |
| Phosphoric acid (85%) g/l | 0.5 | 0.5 |
| Sodium Benzoate g/l | 0.15 | 0.15 |
| Saccharose g/l | 100 | 80 |
| Sucrlose mg/l | | 32 |
| Water | Ad 1000 ml | Ad 1000 ml |
| CO₂ g/l | 5 | 5 |

| | |
|---|---|
| Number of panellists | 34 |
| Correct answers | 25 |
| Likelihood of difference | 99% |
| Significant? | YES |

Again Acesulfame K offered unexpected better options for replacing part of the added sugar, as 30% replacement is not noticeable, while for Aspartame 30% it is significant different to sugar and Sucralose is already at only 20% replacement of added sugar significant different.

### 3) Qualitative Descriptive Analysis of Cola Flavoured Carbonated Soft Drink:

An trained sensory panel, consisting of 10 experienced and trained testers carried out sensory profiling using defined descriptors to measure the taste quality consisting of flavour, flavour profile, sweetness, sweetness profile, off- and side notes, mouthfeel and aftertaste of different cola soft drinks. The different drinks were prepared in a usual way according to formulations given in table 8 and filled up with carbonised water to 1000 ml. The samples include a full sugar comparison and test-beverages, where the sweetness of 20% of the added sugar was replaced by using different high intensity sweeteners.

TABLE 8

| | Concentration | | | | | |
|---|---|---|---|---|---|---|
| | Cola Base | | | | | |
| | g/l Döhler, | | | | | |
| | Art. Nr.: | Sugar | Acesulfam K | Aspartame | Sucralose | Neotame |
| | 200380 | g/l | mg/l | mg/l | mg/l | mg/l |
| 3.1 | 3.1 | 100.0 | | | | |
| 3.2 | 3.1 | 80.0 | 100.0 | | | |
| 3.3 | 3.1 | 80.0 | | 120.0 | | |
| 3.4 | 3.1 | 80.0 | | | 32.0 | |
| 3.5 | 3.1 | 80.0 | | | | 5.0 |

All formulations have been pre-screened in simple comparison tests to have the same sweetness intensity, after that descriptive analysis has been done by the trained panellists to evaluate differences in taste quality.

Graph 1 summarises the results of the quantitative sensory description the panel has given for each attribute. The graph shows the principal component analysis giving an overview of all tested samples and how they correlate with the used descriptors.

The overview graph points out, that when same amount of sugar is replaced by various high intensity sweeteners only with Acesulfame K it is possible to achieve a sugar like taste. Therefore Acesulfame K fulfils advantageously the need to reduce sugar content in regular food-products without taste compromise. Other high intensity sweeteners show significant differences in taste, for example Neotame is related to a long sweetness build and artificial aftertaste or mouthdrying effects, while Sucralose has a pronounced acidity and Aspartame has as well a higher acidity and acidic aftertaste.

1. A method of reducing the amount of added sugar in a food and/or a beverage comprising the steps of:
adding a fraction of a typically added amount of sugar to the food and/or beverage resulting in a lost sweetness; and
adding Acesulfame K as the only high intensity sweetener to the food or beverage to compensate for the lost sweetness.

2. A method of reducing calories in a food and/or a beverage products which typically contain added sugar comprising the steps of:
adding a fraction of a typically added amount of sugar to the food and/or beverage product, thereby creating a loss of sweetness; and
replacing of the loss of sweetness by the addition of Acesulfame K as a single high intensity sweetener.

3. Method of claim 1, wherein the typically added amount of sugar is reduced or decreased by 20 to a maximum of 40% (by weight).

4. Method of claim 1, wherein the lost sweetness is compensated by an equi-sweet amount of Acesulfame K.

5. Method of claim 1, wherein the beverage contains phosphoric acid.

6. Method of claim 1, wherein the beverage contains citric acid.

7. Method of claim 1, wherein the beverage is carbonated.

8. Method of claim 1, wherein the beverage is a cola beverage.

9. Method of claim 1, wherein the beverage is a lemon and/or lime beverage.

10. A food or a beverage containing Acesulfam K as the only high intensity sweetener.

11. (canceled)

12. Method of claim 2, wherein the typically added amount of sugar is reduced or decreased by 20 to a maximum of 40% (by weight).

13. Method of claim 2 wherein the loss of sweetness is compensated by an equi-sweet amount of Acesulfame K.

14. Method of claim 2, wherein the beverage contains phosphoric acid.

15. Method of claim 2, wherein the beverage contains citric acid.

16. Method of claim 2, wherein the beverage is carbonated.

17. Method of claim 2, wherein the beverage is a cola beverage.

18. Method of claim 2, wherein the beverage is a lemon and/or lime beverage.
